(19) United States
(12) Patent Application Publication
(10) Pub. No.: US 2021/0086544 A1
(43) Pub. Date: Mar. 25, 2021

(54) REFLECTIVE SECURITY ELEMENT

(71) Applicant: GIESECKE+DEVRIENT CURRENCY TECHNOLOGY GMBH, Munchen (DE)

(72) Inventors: Winfried HOFFMULLER, Bad Tolz (DE); Christoph HUNGER, Hausham (DE); Kai Herrmann SCHERER, Munchen (DE); Michael SOBOL, Munchen (DE)

(21) Appl. No.: 16/757,555

(22) PCT Filed: Oct. 22, 2018
(86) PCT No.: PCT/EP2018/000481

§ 371 Date: Apr. 20, 2020

(30) Foreign Application Priority Data
Oct. 25, 2017 (DE) 10 2017 009 936.7

(51) Int. Cl. B42D 25/391; B42D 25/324; B42D 25/328; B42D 25/364; B42D 25/373

(52) U.S. Cl. CPC B42D 25/391; B42D 25/324; B42D 25/373; B42D 25/364; B42D 25/328

(57) ABSTRACT

A reflective security element for checking the authenticity with polarized light, has a retroreflective layer and a birefringent layer arranged in a structured manner on the retroreflective layer.

### BACKGROUND

The invention relates to a reflective security element, to a data carrier equipped with such a security element and a method for checking the authenticity of a reflective security element.

Data carriers, such as for example bank notes, shares, bonds, deeds, vouchers, checks, high-value admission tickets, but also other papers at risk of forgery, such as passports or other identity documents, are often furnished for safeguarding purposes with security elements which permit a test of the authenticity of the value document and which at the same time serve as protection from unauthorized reproduction.

In many cases, the special properties of liquid-crystalline materials are utilized for this purpose, with particular emphasis on the viewing angle-dependent colour impression and the special light-polarizing properties of liquid-crystal layers.

Reflective security elements having liquid crystals can be divided into at least two groups. A first group of security elements includes a reflector which reflects in targeted fashion only circularly polarized light and which is formed based on cholesteric liquid crystals. Security elements of the first group can normally be sensed also from a greater distance, since the origin of the light reflected by the security element is irrelevant.

A second group of security elements includes a reflector which not only reflects circularly polarizing light. For example, on the basis of nematic liquid crystals an optically anisotropic layer is arranged above a metallic reflector which does not have a depolarizing effect. For checking the authenticity, a polarizing filter is employed which usually has to be placed directly on the security element, since the light falling onto the security element must already be present in polarized form to ensure that also the reflected light is polarized and can be sensed with the polarizing filter then acting as an analyzer. The direct placing of the polarizing filter is required in particular for minimizing unpolarized false light.

In many application cases, a cholesteric reflector as included in the security elements of the first-mentioned group is undesirable, since such a reflector reflects only in a limited wavelength region and at most half of the light incident in this wavelength region. In addition, false light must be prevented by an absorbent background.

In principle, the group of security elements mentioned second is not suitable for checking the authenticity from an increased observation distance, since in all cases both the incident and the reflected light must be passed through a polarizer/analyzer. Because of the reflection condition “angle of incidence equals angle of reflection”, an authenticity check is therefore only possible if the security element is either almost exactly perpendicular to the direction of irradiation and the direction of observation or if the irradiation unit and the analyzing unit are arranged at exactly the same angle symmetrically to the security element. In many application cases, such a requirement is not realized or cannot be realized at all, so that the use of such security elements of the second group is only possible to a limited extent.

### SUMMARY

On these premises, the invention is based on the object of providing a reflective security element which avoids the disadvantages of the prior art and which can be easily checked for authenticity in particular also from a greater observation distance.

The invention provides a security element for checking the authenticity with polarized light, which includes a retroreflective layer and a birefringent layer arranged in a structured manner on the retroreflective layer.

The combination of a structured birefringent layer with a retroreflective layer offers the decisive advantage that the optical anisotropy of the birefringent layer can be easily interrogated from a greater distance of several meters or even several tens of meters. Because the use of the retroreflective layer achieves that the incident light is reflected onto the light source itself and a small angular region around the light source. Disturbing extraneous light, such as sunlight, room illumination or, in the case of license plates, for example license plate illumination is strongly suppressed at the same time, since only an extremely small part of the extraneous light is reflected in the direction of the illuminator/observer.

In an advantageous configuration of the security element, the birefringent layer is configured with an outline in the form of patterns, characters or a coding. Alternatively, or additionally, the birefringent layer may include two or more regions with different optical effect, which are configured in the form of patterns, characters or a coding. In both cases, during the authenticity check in polarized light there arises a desired image contrast. In the first-mentioned case, the contrast arises between the regions in which the birefringent layer is present and the regions without a birefringent layer, in the case mentioned second the regions of different effects appear with different brightness and/or colour during the authenticity check depending on the type and position of the polarizing filter of the analyzer.

Advantageously, the retroreflective layer comprises a multi-reflective microprismatic layer, which in particular comprises embossed structures with a depth between 10 μm and 1 mm and/or embossed structures with a period length between 10 μm and 1 mm.

Alternatively, or additionally, the retroreflective layer may also comprise focusing, single-reflective structures, in particular spherical gradient-index lenses with mirror-coated backsides, which are also known as Luneburg lenses. A Luneburg lens consists of a sphere of dielectric material as loss-free as possible with location-dependent dielectric constant. Due to its mirror-coated backside, it reflects incident light back exactly in the direction of its source and thus acts as a retroreflector. The refractive index inside the sphere is selected such that parallel incident rays are focused, if possible, in one point which is opposite the contact point of the wave front. For this purpose, it decreases with the distance r from the center and substantially follows the relation

n(r)=Sqrt[2−(r/R)²],

where Sqrt[ ] represents the square root function, R the radius of the sphere and r the distance from the centre of the sphere.

The spherical gradient-index lenses mirror-coated on the backside have in particular a diameter between 20 μm and 200 μm.

The birefringent layer of the security element advantageously comprises a liquid-crystal layer, in particular a nematic liquid-crystal layer. The birefringent layer can also be formed by a single liquid-crystal layer, in particular a nematic liquid-crystal layer. Basically, the birefringent layer can also be formed by an optically anisotropic expanded foil, such as a PET foil or a PP foil, by a birefringent polycarbonate foil, by mica, or by a layer with birefringent pigments.

The mentioned liquid-crystal layer is preferably arranged directly above an alignment layer which is advantageously formed of a linear photopolymer, a finely structured layer or a layer aligned by the application of shear forces.

The birefringent layer advantageously forms a λ/4 layer. Other contrast mechanisms may be based on the employment of dichroic dyes or foils, which in an aligned form absorb light to different extents depending on polarization. Irradiated unpolarized light is selectively linearly polarized by the dye or foil by other polarization portions being absorbed. With a corresponding analyzer, unpolarized light (background of the security element) can then be distinguished from linearly polarized light (in the regions with the dichroic dyes or the foil).

In an advantageous configuration, it is provided that in unpolarized light the security element appears colourless and/or structureless at least in the region of the birefringent layer arranged in a structured manner, so that the structured birefringent layer together with the retroreflective layer forms a hidden security feature that can only be read with aids. In particular in unpolarized light the security element may appear completely colourless and/or structureless, so that without aids it is not recognizable that a security element is present at all.

In some configurations, the security element may also have a hologram or a hologram-like diffraction structure in a partial region. The hologram or the hologram-like diffraction structure here is advantageously formed by an embossing which at the same time represents an alignment layer for the alignment of the liquid-crystal layer. Expediently, the hologram or the hologram-like diffraction structure is furnished with a metallization or a transparent highly refractive layer.

The invention also includes a data carrier having a security element of the described type. The data carrier may in particular be a license plate or other number plate, a value document such as a bank note, a share, a bond, a certificate, a voucher, a cheque, a high-quality admission ticket, or an identity card such as a credit card, a bank card, a cash card, an authorization card, national identity card, a passport or a personalization page.

The invention further includes a method for checking the authenticity of a security element having a polarization feature, in which the security element is exposed to polarized light from any arbitrary direction of exposure, the light reflected by the security element is captured visually or by machine through a polarizer substantially from the direction of exposure, and the polarization feature becoming visible or the predetermined change in its appearance in polarized light is considered to be a sign of authenticity of the security element. In the case of an areal security element, the direction of exposure is in particular not perpendicular to the area of the security element.

In an advantageous variant of the invention, the polarization feature is not even recognizable in unpolarized light and only becomes visible in polarized light when viewed through the polarizer.

Capturing the reflected light is preferably effected visually, but can also be effected by machine, for example by a sensor. The same polarizer can be employed for the polarization of the exposed radiation and the analysis of the reflected radiation. However, since the reflected light is reflected into a small retroreflection cone, also a second analysis polarizer can be employed, which is arranged at a small angular distance from the first polarizer. The second polarizer can then be designed for a different type of polarization (or circular instead of linear) and/or a different polarization direction than the first polarizer in order to obtain an image of the structured birefringent layer with a contrast as high as possible.

In the following, some further details and preferred configurations of the proposed solution are discussed:

If nematic liquid crystals are employed for the birefringent layer and arranged above a retroreflector, the polarization feature can be detected by observation through a polarizing filter after irradiation of the security element with polarized light in the vicinity of the light source. In a simple example, the security element having an anisotropic λ/4 layer (orientation 45°) present in certain regions is irradiated with linearly polarized light (polarizing filter position 0°). The incident light is converted to circularly polarized light by the λ/4 layer. This light is reflected at the boundary surface of Luneburg lenses, for example at a metal layer. The reflected circularly polarized light becomes linearly polarized light with a polarization plane rotated by 90° when passing through the optically anisotropic layer again. If the user views the security element through an analyzer (in the example a linear polarizing filter) in the 0° position, the element appears dark. The bordering adjacent region without an optically anisotropic layer appears bright, however. If one or both polarizing filters are rotated, the contrast ratios may change or even reverse.

The principle explained can be employed, for example, for the illumination of security labels with a polarized flashlight or for the illumination of license plates by one or more polarized headlights of a police car and respective observation through a polarizing filter. Another simple detection technique is the use of a camera with polarizer in front of a flash and in front of the objective. Here, independent polarizers with selectable position relative to each other can be used. This makes it possible to detect the polarization feature even under actually very unfavorable lighting situations (a lot of false light), since the polarized flash light only has to outweigh the false light in the short exposure time.

Nematic liquid crystals as an anisotropic layer have a phase-shifting effect both in visible light and in the adjacent wavelength regions (UV, IR). This also enables a detection by irradiation with non-visible light. For example, the authenticity of a license plate can be checked unnoticed by an infrared flash during speed monitoring with the aid of a suitable analyzer, where applicable with a wavelength filter. The sensors of normal digital cameras are already sufficiently sensitive to IR light for such analysis purposes.

Basically, there are different ways to build up polarization features with nematic liquid crystals. For creating an anisotropy, an alignment of the liquid crystals is required. In order to create different optical conditions at different places on the security element, the optically anisotropic layer can be applied as a motif, it can be applied in locally resolved fashion with different alignment, or the layer material can be fixed in locally resolved fashion in a different state. The fixation can be effected by irradiation with UV light, for example.

The alignment can be effected, for example, by printing the liquid crystals (or a solution including the potentially liquid-crystalline substance) onto a substrate which enables the alignment. This can be a PET foil of good surface quality. If the alignment does not appear to be uniform enough, the uniformity can be improved by a mechanical pre-treatment, for example rubbing with velvet or a relatively soft felt or with suitable cloths, in the desired preferred direction. Almost any desired substrates can be made suitable for alignment by the use of additional alignment layers. Suitable alignment layers are for example polyimides, but also polyvinyl alcohol or gum arabic. In general, the solubility of the polymers forming an alignment layer in the liquid-crystalline substance is very low. The chemical substances mentioned are preferably mechanically pre-structured, although the mechanical pre-structuring has the disadvantage that regions with locally resolved different alignment are sometimes difficult to realize. A locally resolved alignment can be achieved with photoalignment, for example. For this, as an alignment layer a substance is applied which e.g. by exposure to polarized (UV) light obtains a structure which enables the alignment in a defined orientation for the polarization of the UV light. With exposure through a mask and subsequent exposure(s) with different polarization high-resolution motifs can be produced.

Another technique for the locally resolved alignment is the use of embossed structures. The orientation of the embossed structures induces a corresponding orientation of the liquid crystals applied thereon. Since in principle any orientation is possible, grayscale images can be produced in the later security element. But the best contrast is achieved when only two orientations are chosen, namely such that a black-white contrast arises.

The mentioned measures can be carried out either on the target substrate or on a temporary carrier. On the target substrate, the adhesion of the intermediate layer is an important challenge when the construction is effected directly. On a temporary carrier, removability must be ensured. This can be achieved by using classic release layers or by using, for example, a UV lacquer layer which does not adhere strongly to the temporary carrier itself.

Liquid-crystalline material can be applied by dissolving liquid crystals in a suitable solvent, such as butyl acetate, butyl propionate, cyclopentanone, THF, MEK, toluene and mixtures thereof. This solution has a low viscosity and can be applied with classical printing methods/coating methods such as flexographic printing, gravure printing, inkjet, nozzle application and the like. After physical drying, alignment and cross-linking is effected with UV or ESH, for example. Line widths down to about 80 μm can be printed without any problems using classical printing methods.

Alternatively, it is also possible to work without solvents. Here, the liquid-crystalline mixture is melted and printed in the molten state. The viscosity can be adapted to the desired printing method by temperature control. Screen printing and flexographic printing are particularly advantageous. When the chosen printing process does not enable an acceptable local resolution, a structured alignment layer must be used, which enables different orientations of the liquid crystals in the coating region. If the printing method enables a sufficient local resolution, the desired motif can be printed directly, a uniform alignment in the printing region is acceptable and suitable.

Further layers in the finished product are also important for the optical effect. Cast foils normally are optically isotropic and do not interfere with the polarization effect. When optically anisotropic layers (for example expanded foils) are present in the entire observed region (product surface through reflection layer/region) or scattering occurs such as by pigments or fillers, this can be harmless for the overall effect when, for instance, the dispersion of an additional optically anisotropic layer is not too strong in the light wavelength region in which the observation occurs.

The retroreflective layer must be designed such that upon irradiation of polarized light it reflects polarized light back. The polarization of the light may be changed, but no strong depolarization may occur and the possibly occurring change in polarization should be largely uniform over the entire region of the security element. Luneburg lenses and microprismatic structures have proven to be particularly suitable retroreflective layers. A high retroreflection and a disturbance of the polarization as small as possible are advantageous.

The security element may extend over the full area of the data carrier (for example the entire license plate), but it can also be used on parts of the area as a strip or patch. When used as a transfer patch, from which the carrier foil is removed in a subsequent step, several concentric circumferential lines can be punched to prevent uncontrolled flutter. In addition, further lines and motifs can be punched into the patch, which make it more difficult to remove them from the later data carrier, but do not hinder the manufacturing process.

While polarization features based on nematic liquid crystals in the field of bank notes usually have the polarization filter placed directly on the security feature and thus the polarizer and analyzer are equally constituted (namely inevitably identical) and additionally are present in the same position, the requirements and possibilities for labels and license plates having retroreflective properties are different. When, for example, the light source used for verification is furnished with a linear polarization filter, it is quite possible that due to birefringent layers in the ray path a different, for example elliptical polarization of the light returns and must be analyzed with optimal contrast. Therefore, in one configuration, either the polarizer or the analyzer may carry additional birefringent layers in order to achieve in sum an optimal contrast.

A further embodiment is the additional introduction of a full-area birefringent layer for the security feature in order to compensate for birefringent layers which for technical reasons are already present. This may either be a full-area liquid-crystalline layer of suitable alignment or, for example, a birefringent foil, such as an expanded foil. This effect can also be exploited for less finely structured polarization features.

If a birefringent foil is laminated or employed as an intermediate layer from which certain characters, patterns, symbols and the like are punched out, the pattern can be detected in the same way as for positive patterns, signs or codings.

Another possibility is to destroy the foil's birefringence present after manufacturing by means of a suitable post-treatment. This can be effected by a brief strong heating, for example by means of laser, or also by dissolving the foil material (if soluble by local application of solvent) and, where applicable, drying/resolidifying, as a result of which in certain regions a birefringent expanded foil and in certain regions a foil analogous to a cast foil is present.

### BRIEF DESCRIPTION OF THE DRAWINGS

Further embodiment examples as well as advantages of the invention will be explained hereinafter with reference to the figures, in whose representation a rendition that is true to scale and to proportion has been dispensed with in order to increase the clearness.

There are shown:

FIGS. 1(a) to 1(c) in 1(a) schematically the basic principle of checking the authenticity of a retroreflective security element present on a data carrier, for example a license plate, in 1(b) the colourless and structureless appearance of the security element under normal illumination conditions, and in 1(c) the appearance of the security element in polarized light in the analyzer with the writing “OK”,

FIGS. 2(a) and (b) the basic construction of security elements according to the invention in two variants,

FIG. 3 a more detailed explanation of the mode of function of the security element of FIG. 2(a) in an exploded representation,

FIG. 4 a cross-section of a first polarization feature,

FIG. 5 a representation as in FIG. 4 for another polarization feature,

FIGS. 6(a) to 6(c) three configurations of a second polarization feature,

FIG. 7 an illustration of the further processing of the polarization features of FIGS. 6(a) to 6(c) into a punched-out structured patch,

FIG. 8 a security element with a retroreflective layer and a patch according to FIG. 7, and

FIGS. 9(a) to 9(c) license plates having security elements according to FIG. 8, in 9(a) with a patch in the form of a coat of arms, in 9(b) with a full-area security foil with a plurality of coat-of-arms-shaped patches and in 9(c) with a full-area security foil with coat-of-arms-shaped recesses.

### DETAILED DESCRIPTION OF VARIOUS EMBODIMENTS

The invention will now be explained in more detail by the example of security elements for license plates. It is to be understood, however, that the security elements described can also be used, for example, as security labels for value documents or for marking products.

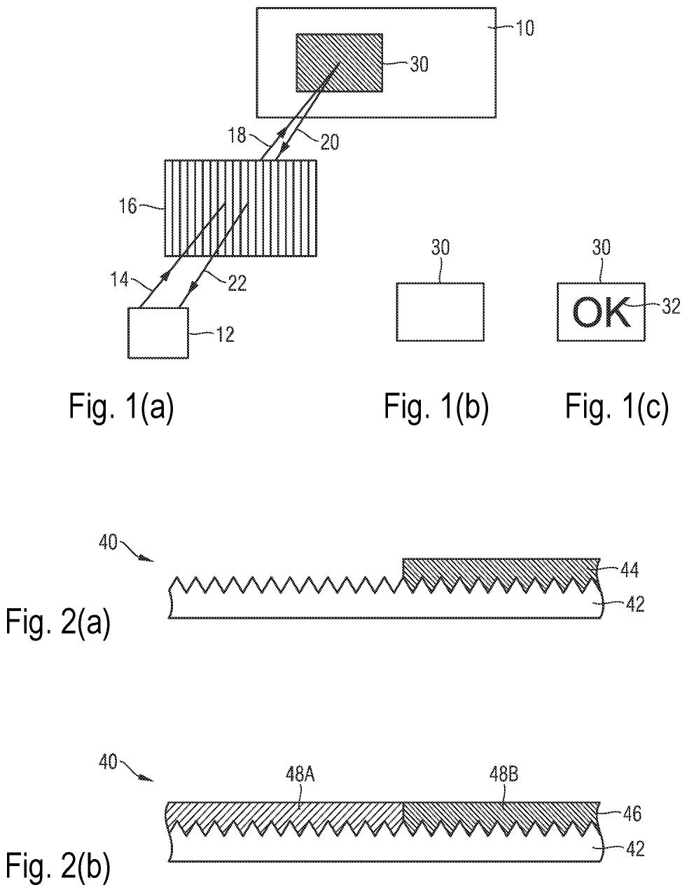

FIG. 1(a) schematically illustrates the basic principle of checking the authenticity of a retroreflective security element 30 present on a data carrier, for example a license plate 10, according to an embodiment example of the invention. The security element 30 is hatched in FIG. 1(a) for illustration purposes, under normal illumination conditions the security element 30 actually appears colourless and structureless as shown in FIG. 1(b), so that its presence is not readily recognizable.

For checking the authenticity, the retroreflective security element 30 of the license plate 10 is exposed to polarized light and the light retroreflected by the security element 30 is viewed through an analyzer, as shown in FIG. 1(a). For example, a user 12 polarizes unpolarized light 14 by a linear polarizer 16 and the license plate 10 is exposed to the polarized light 18. Due to the retroreflective properties of the security element 30, the reflected light 20 travels back to the user 12 within a small retroreflection cone and in doing so passes the linear polarizer 16 again. As will be explained in more detail below, the light 22 that has passed through the linear polarizer 16 is no longer structureless due to the previous influence on the polarization state of the light in the security element 30, but rather shows a desired appearance 32 as proof of authenticity. For example, in polarized light the security element 30 may appear in the analyzer with the writing “OK”, as shown in FIG. 1(c).

As a specialty, this authenticity check can be carried out by the user 12 from practically any locations, since it is ensured by the retroreflective properties of the security element 30 that the incident light 18 is always reflected back to the user 12.

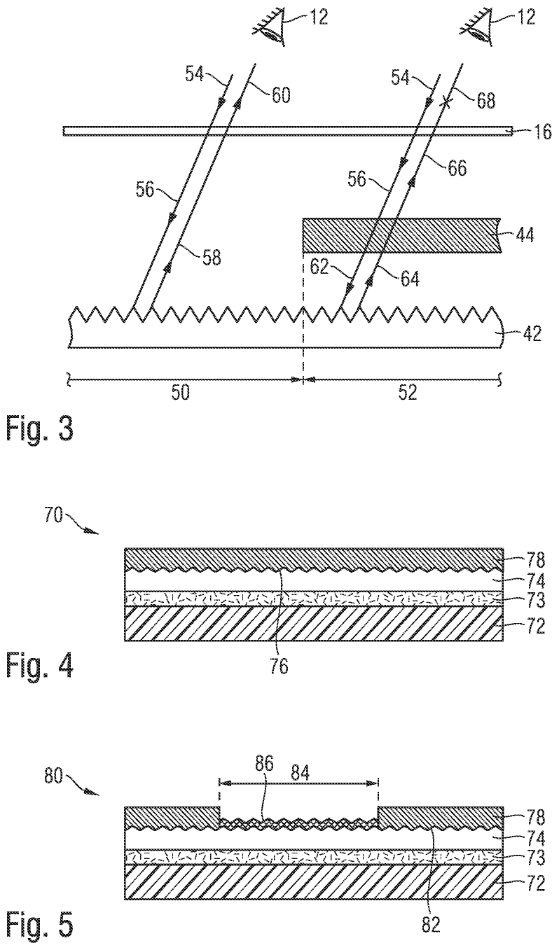

FIGS. 2(a) and 2(b) show the basic construction of security elements according to the invention. The mode of function of the security elements is explained in more detail in the exploded representation in FIG. 3 by the example of the configuration of FIG. 2(a).

With reference first to FIG. 2(a), a security element 40 according to the invention comprises a retroreflective layer 42 and a birefringent layer 44 applied in certain regions in the form of the writing “OK”. The retroreflective layer 42, for example, is formed on the basis of microprismatic structures, and the birefringent layer is, for example, a nematic liquid-crystal layer which due to its layer thickness acts as a λ/4 layer.

In the modification of FIG. 2(b) the birefringent layer 46 is present over the full area and includes different regions 48A, 48B with different optical effects, which are configured in the form of the writing “OK”. For example, the regions 48A represent the letters of the writing “OK” and the regions 48B the complementary background regions.

With reference to FIG. 2(a) and FIG. 3, the retroreflective layer 42 of the security element 40 in this configuration is applied only in certain regions, namely in the form of the writing “OK”, so that in addition to the regions 52 in which a nematic λ/4 liquid-crystal layer 44 is present, there are also regions 50 without a nematic liquid-crystal layer.

If now, corresponding to the explanation for FIG. 1(a), unpolarized light 54 sent out by the user 12 from a light source is polarized by a linear polarizer 16, the polarized light 56 in the regions 50 without nematic layer 44 impinges on the retroreflective layer 42 and is reflected back in the direction of incidence substantially without changing the polarization state of the incident light. The reflected light 58 therefore has the same polarization state as the incident light 56 and can pass the linear polarizer 16 unhindered (reference sign 60). For the user 12, the regions 50 therefore appear bright in polarized light.

In regions 52 with the λ/4 nematic layer 44, the linearly polarized light 56 is converted by the nematic layer into circularly polarized light 62. The circularly polarized light 62 impinges on the retroreflective layer 42 and is reflected back by it in the direction of incidence. The reflected circularly polarized light 64 passes through the λ/4 nematic layer 44 again and in doing so is converted into linearly polarized light 66 whose polarization vector, however, is now perpendicular to the initial polarization. The linearly polarized light 66 can therefore not pass the linear polarizer 16 (reference sign 68), so that the regions 52 appear dark to the observer 12.

Because of the small but in practice finite opening cone of the retroreflection, the polarizer for polarizing the incident light and the analyzer for viewing the light reflected from the security element may also be slightly apart from each other. For example, the polarizer may be arranged on the headlamp of a police car, while the analyzer is present in a pair of glasses worn by a police officer sitting in the police car.

If polarizer and analyzer are spatially separated, they can also be configured differently. For example, the polarizer can be a linear polarizer and the analyzer can be a circular polarizer or a linear polarizer with a different polarization vector.

Examples of concrete configurations of security elements of the invention are now described in more detail with reference to FIGS. 4 to 9.

First, FIG. 4 shows a cross-section of a first polarization feature 70. For manufacturing the first polarization feature 70, a PET foil 72 with a thickness of 23 μm is provided and furnished with a UV lacquer as a release layer 73 and a further UV embossing lacquer layer 74. Into the embossing lacquer layer 74 the desired hidden motif is embossed with an alignable structure 76. Additionally, a hologram embossing can also be performed in the same processing step. A nematic liquid-crystalline solution is printed onto the alignable structure 76. After physical drying, the nematic layer 78 is present in a layer thickness between 0.8 μm and 3 μm, preferably of about 1.2 μm. During and after physical drying, the liquid crystals are aligned by the alignment structure 76. Subsequently, the liquid crystals are crosslinked, for example by UV exposure, preferably at reduced oxygen concentration (nitrogen inertization). Configurations in which the PET foil 72 is to remain in the finished security element are configured without release layer 73.

Subsequently, a structured or unstructured metal layer, for example of aluminium or chrome, can be applied. The structuring can be effected, for example, by covering a partial region with a washable ink, metallization and subsequently removing the washable ink with the metallization applied thereon. Of course, other structuring methods, such as etching methods, can also be used.

For further processing, the polarization feature 70 is furnished with primer(s) and heat-seal lacquers or other adhesives and applied onto the desired target substrate. The manufacturing may also include a cutting and/or punching operation to transfer the polarization feature 70 with a desired shape. The application can be carried out in such a way that only partial regions of the formed polarization feature are transferred, while other partial regions remain on the carrier foil 72. In other configurations, partial regions of the polarization feature can be removed from the carrier foil 72 before the transfer and the remaining partial regions can then be transferred completely.

The polarization feature 80 of FIG. 5 is constructed basically like the polarization feature 70, where the UV embossing lacquer layer 74 in the embodiment example of FIG. 5 is furnished with an embossing 82 which represents an alignment embossing for aligning the liquid crystals of the nematic layer 78 as well as a hologram embossing. In partial areas 84, in which instead of the liquid-crystal layer a metallization 86 is applied on the embossing 82, a reflection hologram becomes visible upon viewing.

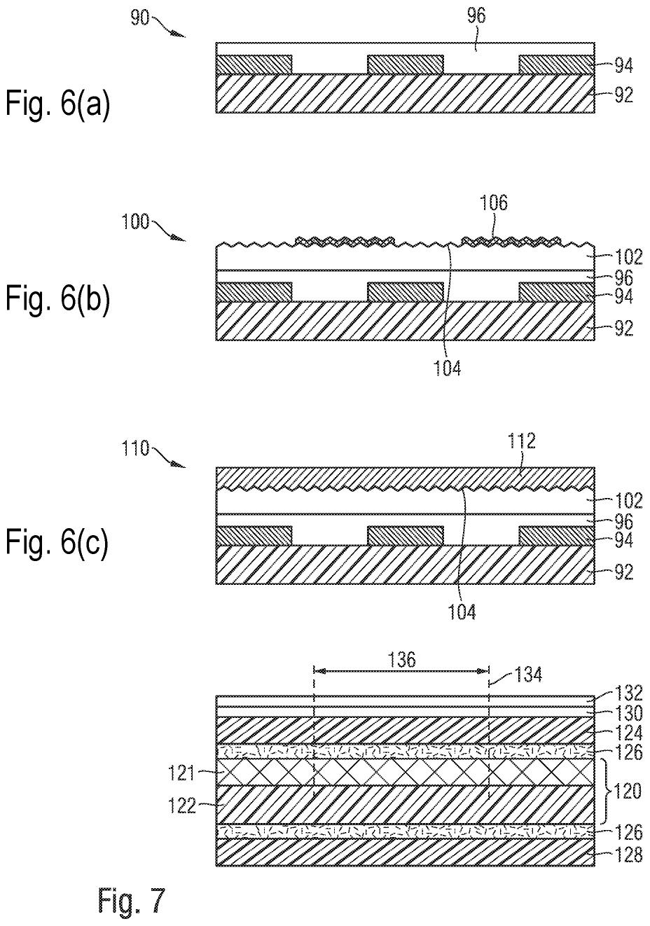

FIG. 6(a) shows an embodiment example of a second polarization feature 90. For manufacturing the second polarization feature 90, a smooth PET foil 92 with good surface quality and a thickness of 23 μm is provided and directly printed with a liquid-crystalline solution to form the desired hidden motif, for example in gravure printing. Subsequently, the liquid-crystalline solution is dried and crosslinked. More precisely, the printed solution itself is not yet in the liquid-crystalline state, rather the substances included enter into the nematic liquid-crystalline state only during and after physical drying and form a structured nematic liquid-crystal layer 94. For the transfer of the nematic layer, a transfer auxiliary layer 96 in the form of a UV lacquer layer is provided. The surface energy thereof can be adjusted such that both PET foil 92 and liquid crystals 94 can be coated without any problems. If this is not desired in some configurations, a mechanical, forced wetting of the liquid crystals during or immediately after crosslinking can also be effected.

The variant of FIG. 6(b) is based on the configuration of FIGS. 6(a) to 6(c). In addition, in the polarization feature 100 of FIG. 6(b), a UV embossing lacquer 102 is applied on the UV lacquer layer 96, embossed with a hologram embossing 104, and furnished with a metallization 106 in some regions. In the polarization feature 110 of FIG. 6(c), likewise, a UV embossing lacquer 102 is applied on the UV lacquer layer 96, provided with a hologram embossing 104, and overlaid with a higher-refractive UV lacquer 112. The hologram motif of the hologram embossing becomes visible, in this embodiment example, through the difference in the refractive index of the lacquer layers 102, 112.

The further processing of the polarization features of FIGS. 6(a) to 6(c) can be effected as in the polarization features of FIGS. 4 and 5. FIG. 7 illustrates this further processing into a punched-out structured patch. The starting point here is a polarization feature 120 having a carrier foil 122, for example according to one of the embodiment examples of FIG. 4, 5 or 6(a), (b) or (c).

Onto the lacquer side of the polarization feature 120 of FIG. 7 an approximately 12 μm thick PET foil 124 is laminated with a laminating adhesive 126. On the opposite side, a supporting foil 128, also 12 μm thick, is laminated with a laminating adhesive 126. Further layers, such as primer layers 130 and suitable heat-sealing layers 132, are then applied onto the foil of the former lacquer side. The thus resulting layered composite is then punched from the lacquer side (reference number 134) to such an extent that the polarization feature 120 with the included liquid-crystal layer 78 or 94 and the, where applicable, also included transfer auxiliary layer 96 is punched. Ideally, the punching ends at the carrier foil 122, but a marginal punching of the carrier foil 122 does not matter, as the supporting foil 128 prevents a further tearing.

The intermediate regions between the patches 136 produced in this way can be stripped off. Possibly required control marks are advantageously printed onto the opposite side or are retained in the process of stripping off. Finally, the foil with the layered composite is suitably cut. As the adhesive is only present in the region of the patches 132, the geometry of a stamp employed for the application is not critical. Only the desired unit is respectively transferred. The removal from the carrier foil 122 can be supported by suitable adjustment of the peel angle, for example with dispensing wedges.

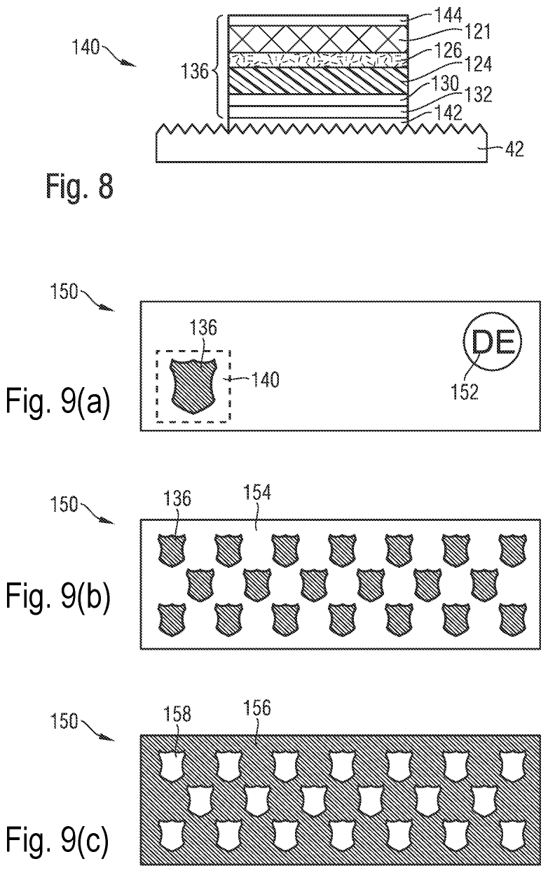

FIG. 8 shows a security element 140 according to the invention having a retroreflective layer 42, which in certain regions has patches 136 applied thereon via suitable intermediate layers 142 according to FIG. 7. The layer sequence 121 of the polarization feature 120 here is configured, for example, analogous to FIG. 4, i.e. it comprises an approximately 1.2 μm thick nematic layer 78 and a UV embossing lacquer layer 74 for the alignment of the liquid crystals. The patches 136 are applied for example with the outline of a desired symbol, such as a coat of arms, or with the outline of a desired writing, such as the writing “OK” shown in FIGS. 1(a) to 1(c). After the application, the patches are then furnished with suitable cover layers 144, for example a protective layer.

The patches 136 are colourless and structureless under normal illumination conditions and only appear when illuminated with polarized light and when the reflected light is viewed through a polarizing filter.

For illustration, FIG. 9(a) shows a license plate 150 which in a partial region has laminated thereon a security element 140 according to FIG. 8 with a patch 136 in the form of a coat of arms. The coat of arms 136 is not visible under normal illumination conditions, but only appears when the license plate 150 is illuminated with polarized light and when the reflected light is viewed through a polarizing filter. In the embodiment example of FIG. 9(a), a conventional hologram patch 152 is additionally shown, which is also visible under normal illumination conditions.

In the embodiment example of FIG. 9(b), the license plate 150 has laminated over the full area thereon a security foil 154 which is basically configured like the security element 140 of FIG. 8 and carries a plurality of regularly spaced, coat-of-arms-shaped patches 136. FIG. 9(c) shows an inverse configuration, in which there has been laminated over the full area of the license plate 150 a security foil 156 of the type described in FIG. 8 from which coat-of-arms-shaped symbols 158 have previously been punched out.

In both configurations, the positive coats of arms of FIG. 9(b) and the negative coat-of-arms-shaped recesses of FIG. 9(c) are not visible under normal illumination conditions, but only appear when the number plate 150 is illuminated with polarized light and when the reflected light is viewed through a polarizing filter.

1.-16. (canceled)

17. A reflective security element for checking the authenticity with polarized light, having a retroreflective layer and a birefringent layer arranged in a structured manner on the retroreflective layer.

18. The reflective security element according to claim 17, wherein the birefringent layer is configured having an outline in the form of patterns, characters or a coding.

19. The reflective security element according to claim 17, wherein the birefringent layer includes two or more regions with different optical effects, which regions are configured in the form of patterns, characters or a coding.

20. The reflective security element according to claim 17, wherein the retroreflective layer comprises a multi-reflective microprismatic layer.

21. The reflective security element according to claim 20, wherein the microprismatic layer comprises embossed structures having a depth between 10 μm and 1 mm and/or a period length between 10 μm and 1 mm.

22. The reflective security element according to claim 17, wherein the retroreflective layer comprises focusing, single-reflective structures, in particular spherical gradient-index lenses mirror-coated on the backside.

23. The reflective security element according to claim 22, wherein the spherical gradient-index lenses have a diameter between 20 μm and 200 μm.

24. The reflective security element according to claim 17, wherein the birefringent layer comprises a liquid-crystal layer, in particular a nematic liquid-crystal layer.

25. The reflective security element according to claim 24, wherein the liquid-crystal layer is arranged directly above an alignment layer, which is preferably formed from a linear photopolymer, a finely structured layer or a layer aligned by the action of shear forces.

26. The reflective security element according to claim 17, wherein the birefringent layer forms a λ/4 layer.

27. The reflective security element according to claim 17, wherein the security element appears colorless and/or structureless in unpolarized light at least in the region of the birefringent layer arranged in a structured manner.

28. The reflective security element according to claim 17, wherein the security element in a partial region has a hologram or a hologram-like diffraction structure.

29. The reflective security element according to claim 28, wherein the hologram or the hologram-like diffraction structure is formed by an embossing which at the same time represents an alignment layer for the alignment of the liquid-crystal layer.

30. The reflective security element according to claim 28, wherein the hologram or the hologram-like diffraction structure is furnished with a metallization or a transparent highly refractive layer.

31. A data carrier, in particular license plate, having a security element according to claim 17.

32. A method for checking the authenticity of a security element having a polarization feature, in which the security element is exposed to polarized light from any arbitrary direction of exposure, the light reflected by the security element is captured visually or by machine through a polarizer substantially from the direction of exposure, and the polarization feature becoming visible or the predetermined change in its appearance in polarized light is considered to be a sign of authenticity of the security element.
